(19) United States
(12) Patent Application Publication
(10) Pub. No.: US 2005/0066691 A1
(43) Pub. Date: Mar. 31, 2005

(54) Method of reinforcing fiber mat for building insulation

(75) Inventors: John O. Ruid, Schwenksville, PA (US); Kurt Mankell, Blue Bell, PA (US); Alain Yang, Bryn Mawr, PA (US); Wayne Shaw, Glen Mills, PA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: CERTAINTEED CORPORATION, VALLEY FORGE, PA (US)

(21) Appl. No.: 10/778,330

(22) Filed: Feb. 17, 2004

Related U.S. Application Data
(63) Continuation of application No. 10/421,934, filed on Apr. 24, 2003, now abandoned.
(63) Continuation of application No. 09/946,586, filed on Sep. 6, 2001, now abandoned.

(51) Int. Cl. C03C 17/02

(52) U.S. Cl. 65/444

(57) ABSTRACT

Reinforced fiber insulation is formed by depositing a mixture of textile fiber segments and rotary and/or flame attenuated segments on a surface, mixing a binder with the fibers, and heating the binder to join the fibers together. The low cost process provides a mixed fiber insulation product with improved strength after compression.

### BACKGROUND OF THE INVENTION

1. Field of the Invention

This invention relates to fiber insulation. More specifically, this invention relates to methods of reinforcing insulation products containing fibers.

2. Description of the Background

Glass and polymer fiber mats positioned in the gap between two surfaces can be used to reduce the passage of heat and noise between the surfaces.

Heat passes between surfaces by conduction, convection and radiation. Because glass and polymer fibers are relatively low thermal conductivity materials, thermal conduction along glass and polymer fibers is minimal. Because the fibers slow or stop the circulation of air, mats of the fibers reduce thermal convection. Because fiber mats shield surfaces from direct radiation emanating from other surfaces, the fiber mats reduce radiative heat transfer. By reducing the conduction, convection and radiation of heat between surfaces, fiber mats provide thermal insulation.

Sound passes between surfaces as wave-like pressure variations in air. Because fibers scatter sound waves and cause partial destructive interference of the waves, a fiber mat attenuates noise passing between surfaces and provides acoustic insulation.

Conventional mineral fiber mats or webs used in buildings as thermal and acoustic insulation are made primarily from rotary or flame attenuated fibers, or from rock wool. Rotary fibers and flame attenuated fibers are relatively short, with lengths on the order of 1 to 5 cm, and relatively fine, with diameters of 3 μm to 5 μm.

In order to reduce storage and transportation costs, fiber mats are often highly compressed on the production line and then auto-decompressed to recover their initial thickness by removing packaging materials at the job site. However, decompressed fiber mats made of rotary or flame attenuated fibers frequently do not completely recover their nominal pre-compression thickness.

Fiber mats could be made of textile fibers, which are stronger than rotary or flame attenuated fibers. However, because textile fibers tend to be more expensive than rotary and flame attenuated fibers, fiber mats of textile fibers could be prohibitively expensive.

There is a need for a method of manufacturing an inexpensive fiber mat that, after compression, is strong enough to decompress to close to its nominal pre-compression thickness.

### SUMMARY OF THE INVENTION

The present invention provides an efficient method of producing strong insulation products containing rotary and/or flame attenuated fibers reinforced with textile fibers. According to the invention, textile fibers segments and rotary and/or flame attenuated fibers are mixed together with a binder spray, deposited onto a forming belt, and cured. The resulting fibrous mat exhibits an improved strength that allows for greater compression during storage and transportation to achieve the same thickness recovery after decompression.

### BRIEF DESCRIPTION OF THE DRAWINGS

The preferred embodiments of the invention will be described in detail, with reference to the following figures, wherein:

FIG. 1 shows a method of forming a mat of rotary glass fibers reinforced with segments of textile glass fiber.

### DETAILED DESCRIPTION OF PREFERRED EMBODIMENTS

The present invention provides a method of forming a fiber mat in which rotary and/or flame attenuated fibers are reinforced with segments of textile glass fibers.

The inventive method of forming reinforced fiber insulation includes spinning rotary and/or flame attenuated fibers. The well-blended rotary and/or flame attenuated fibers and textile fiber segments are then deposited together in a mixture on a surface. A binder is mixed with the rotary and/or flame attenuated fibers and the textile fiber segments to form a primary mat. The primary mat is heated to cause the binder to bond the various fibers and fiber segments together, resulting in a reinforced fiber insulation product.

Preferably the textile fiber segments and the rotary and/or flame attenuated segments are mixed in the same hood. The textile fibers segments can be mixed with the rotary and/or flamed attenuated fibers by blowing precut textile fiber segments into the hood while the rotary and/or flame attenuated fibers are being made. Preferably, the textile fiber segments are formed inside the same hood and at the same time as the rotary and/or flame attenuated fibers. This can be accomplished by feeding one or more long continuous textile fibers into the hood and dividing the textile fibers into textile fiber segments while the rotary and/or flame attenuated fibers are formed. The textile fibers can be divided into segments using a sharp tool to chop and cut the textile fibers, or by using other means for dividing objects known in the art. Chopped textile fibers can be readily produced by techniques used currently in producing boat hulls and the like.

The binder can be mixed with the rotary and/or flame attenuated fibers and the textile fibers by spraying the binder onto the fibers after the fibers are deposited onto a surface. Preferably, the binder can be sprayed in the hood so that the rotary and/or flame attenuated fibers, and the textile fiber segments, pass through the binder spray before the fibers are deposited onto the surface. The binder can be sprayed as part of a mixture of the binder and a liquid carrier.

The reinforced fiber mat can be formed in a batch process on a stationary surface. Preferably, the reinforced fiber mat is formed continuously on a moving surface, such as a conveyor belt or a forming belt.

Preferably, the textile fiber segments and the rotary and/or flame attenuated fibers intermingle in the primary mat. More preferably, the primary mat includes a uniform mixture of the textile fiber segments and the rotary and/or flame attenuated fibers.

In embodiments, the reinforced fiber insulation is in the form of a batt, mat or blanket. The fibers in the reinforced insulation form a porous nonwoven structure. A preferred porous structure is that found in FIBERGLASS.

The fibers in the reinforced fiber insulation can be organic or inorganic. Suitable organic fibers include polymer fibers, such as rayon and polyester. Preferably, the fibers are inorganic. Inorganic fibers include rock wool and glass wool.

Preferably, the fibers are inorganic and comprise a glass. The glass can be, for example, an E-glass, a C-glass, or a high boron content C-glass.

In embodiments, each of the textile and rotary and/or flame attenuated glass fibers can be made of the same material. In other embodiments, the textile fibers can be made from one material, and the rotary and/or flame attenuated glass fibers can be made from a different material. In still other embodiments, different textile fibers can each be made from different materials; and different rotary or flame attenuated glass fibers can be made from different materials. Cost and insulation requirements will dictate the selection of the particular materials used used in the textile, rotary and flame attenuated fibers. Preferably, the textile fibers are formed from starch coated or plastic coated E-glass and the rotary and flame attenuated fibers are formed from high boron C-glass.

Textile, rotary and flame attenuated fibers can be made in various ways known in the art. For example, textile fibers can be formed in continuous processes in which molten glass or polymer is extruded and drawn from apertures to lengths on the order of one mile. For use in insulation, the long textile fibers are divided into short segments by cutting techniques known in the art. Rotary fibers can be made or spun by using centrifugal force to extrude molten glass or polymer through small openings in the sidewall of a rotating spinner. Flame attenuated fibers can be formed by extruding molten glass or polymer from apertures and then blowing the extruded strands at right angles with a high velocity gas burner to remelt and reform the extruded material as small fibers.

The textile fibers used to reinforce the insulation product of the present invention have diameters of from greater than 5 μm to about 16 μm. Preferably the textile fibers are divided into segments with lengths of about 1 cm to about 8 cm, more preferably from about 2 cm to about 4 cm. The rotary and flame attenuated fibers have diameters of from about 3 μm to 5 ρm. Preferably the rotary and flame attenuated fibers have lengths of about 1 cm to about 5 cm, more preferably from about 1 cm to about 3 cm.

The binder mixed with the textile fiber segments and the rotary and/or attenuated fibers can be a thermosetting polymer, a thermoplastic polymer, a combination of both thermoplastic and thermosetting polymers, or an inorganic bonding agent. Preferably, the thermosetting polymer is a phenolic resin, such as a phenol-formaldehyde resin, which will cure or set upon heating. The thermoplastic polymer will soften or flow upon heating above a temperature such the melting point of the polymer. The heated binder will join and bond the fibers. Upon cooling and hardening, the binder will hold the fibers together. When binder is used in the insulation product, the amount of binder can be from 1 to 15 wt %, preferably from 2 to 12 wt %, more preferably from 3 to 10 wt %.

In embodiments, the thickness of the reinforced fiber insulation can be in a range from 20 to 350 mm, preferably from 50 to 300 mm, more preferably from 70 to 260 mm. The percentage of textile fiber in the product can be in a range of 1 to 15%, preferable from 2% to 12% and, more preferable from 3% to 8%. The higher the percentage of textile fiber, the stronger the product. However, higher percentages of textile fiber lead to an increase in production costs.

### EXAMPLES

The following non-limiting example will further illustrate the invention.

### Example 1

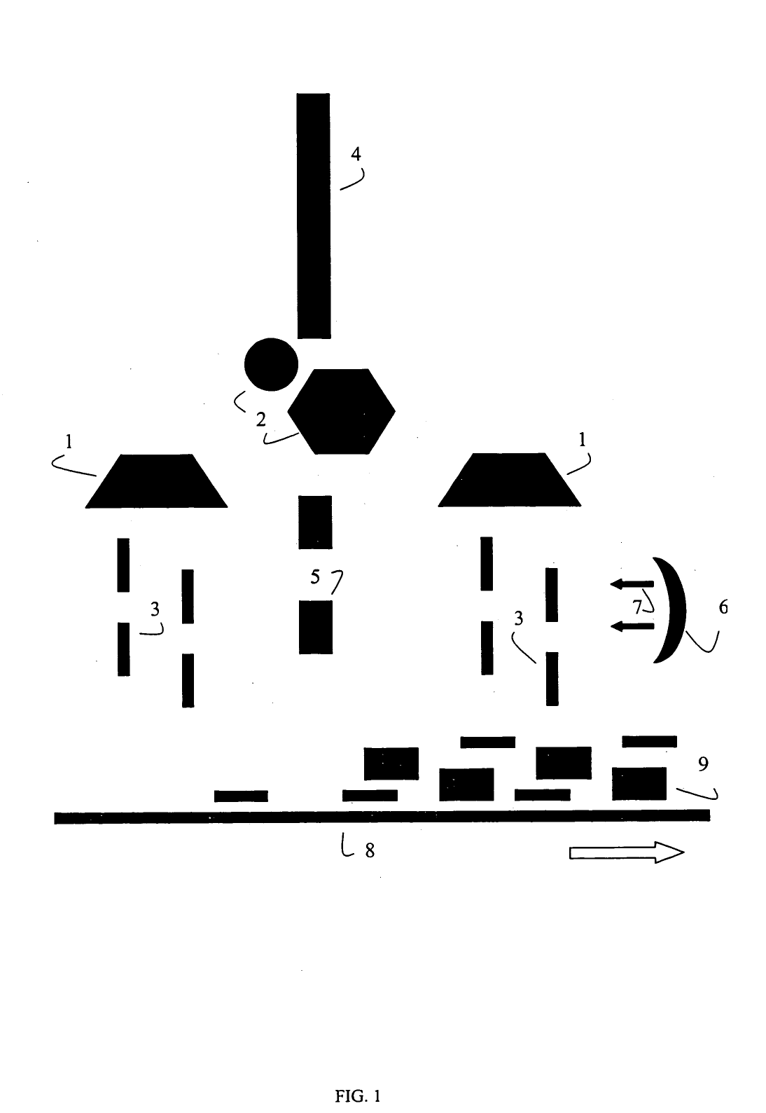

FIG. 1 shows an embodiment of the invention in which a plurality of rotary glass fiber spinners 1 and a textile glass fiber cutter 2 are located inside the same hood (not shown). Molten glass is extruded from spinners 1 to form rotary glass fibers 3. Continuous textile glass fiber 4 is fed to cutter 2 where the textile glass fiber 4 is divided into textile glass fiber segments 5. In embodiments any number of rotary glass spinners 1 and textile glass fiber cutters 2 can be combined in the same hood. Rotary glass fibers 3 and textile glass fiber segments 5 can be mixed by air circulating in the hood as the fibers fall in the hood. Spray nozzle 6 sprays a binder spray containing binder 7 into the falling rotary glass fibers 3 and textile glass fiber segments 5. The rotary glass fibers 3, textile glass fiber segments 5, and binder 7 deposit on forming belt 8 to form primary mat 9. The primary mat 9 is heated in an oven (not shown). The heated binder 7 flows, captures and holds together the rotary glass fibers 3 and the textile glass fiber segments 5. The binder 7 solidifies upon cooling, resulting in a reinforced fiber mat.

While the present invention has been described with respect to specific embodiments, it is not confined to the specific details set forth, but includes various changes and modifications that may suggest themselves to those skilled in the art, all falling within the scope of the invention as defined by the following claims.

1. A method of forming reinforced fiber insulation, the method comprising
spinning first fibers each having a diameter of from about 3 μm to 5 μm and a length of from about 1 cm to about 5 cm;
providing second fiber segments each having a diameter of from greater than 5 μm to about 16 μm and a length of from about 2 cm to about 15 cm;
depositing a mixture of the first fibers and the second fiber segments on a surface;
mixing a binder with the first fibers,and the second fiber segments;
forming the first fibers, the second fibers segments, and the binder into a primary mat;
heating the primary mat to cause the binder to bond together the first fibers and the second fiber segments; and
forming the reinforced fiber insulation.

2. The method according to claim 1, wherein the providing second fiber segments comprises a step for dividing second fibers into second fiber segments.

3. The method according to claim 2, wherein the second fibers are textile fibers formed by a continuous drawing process.

4. The method according to claim 1, wherein the providing second fiber segments comprises dividing second fibers into the second fiber segments.

5. The method according to claim 4, wherein the second fibers are textile fibers formed by a continuous drawing process.

6. The method according to claim 4, wherein the dividing comprises chopping the second fibers.

7. The method according to claim 4, wherein the spinning and the dividing are both performed in the same hood.

8. The method according to claim 1, wherein the first fibers are spun by a rotary process or a flame attenuation process.

9. The method according to claim 1, wherein the mixing comprises spraying the binder on the first fibers and the second fiber segments.

10. The method according to claim 1, wherein the mixing comprising passing the first fibers and the second fiber segments through a spray comprising the binder before the first fibers and the second fiber segments are deposited on the surface.

11. The method according to claim 1, wherein the surface is a moving surface.

12. The method according to claim 9, wherein the moving surface is a forming belt.

13. The method according to claim 1, wherein the first fibers comprise a glass.

14. The method according to claim 13, wherein the glass is selected from the group consisting of an E-glass, a C-glass, and a boron doped C-glass.

15. The method according to claim 1, wherein the second fiber segments comprise a glass.

16. The method according to claim 15, wherein the glass is selected from the group consisting of an E-glass, a C-glass, and a boron doped C-glass.

17. The method according to claim 1, wherein the binder comprises a polymer.

18. The method according to claim 1, wherein the first fibers and the second fiber segments intermingle in the primary mat.

19. The method according to claim 1, wherein the primary mat is a uniform mixture of the first fibers and the second fiber segments.

20. The method according to claim 1, wherein the reinforced fiber insulation is a batt, mat or blanket.
